(19) United States
(12) Patent Application Publication
(10) Pub. No.: US 2010/0079346 A1
(43) Pub. Date: Apr. 1, 2010

(54) UNIVERSAL ENCLOSURE SYSTEM

(75) Inventors: Steven C. Olson, Broomfield, CO (US); David E. Dyke, Fort Collins, CO (US); Chad E. Dewey, Golden, CO (US); Craig S. Leahy, Westminster, CO (US)

Correspondence Address: ANCEL W. LEWIS, JR., 425 WEST MULBERRY, SUITE 101, FORT COLLINS, CO, 80521, US

(73) Assignee: ARC WIRELESS SOLUTIONS, INC., Wheat Ridge, CO (US)

(21) Appl. No.: 12/566,842

(22) Filed: Sep. 25, 2009

Related U.S. Application Data
(60) Provisional application No. 61/101,226, filed on Sep. 30, 2008.

(51) Int. Cl. H01Q 1/24

(52) U.S. Cl. 343/702

(57) ABSTRACT

An enclosure system for a radio board and an antenna circuit has a downwardly opening, concave housing with a interior housing cavity, a base that fits across the bottom of the housing, and a mounting plate that mounts on the base and extends into the housing cavity. The radio board and antenna mount on the mounting plate. A transparent cable access door has spaced knockouts that allow routing of communication interface cables. Mounting bolts attached to the exterior of the housing allow mounting of a mounting bracket. The bottom of the base is flat for placement on a flat surface.

This application claims the benefit under 35 U.S.C. §119(e) of the U.S. provisional patent application No. 61/101,226 filed Sep. 30, 2008.

### TECHNICAL FIELD

The present invention relates to circuit board mounting systems and more particularly to an enclosure system for mounting radio boards and antennas of varying sizes and with varying connector locations.

### BACKGROUND ART

Radio boards and antennas are often integrated into the same enclosure system in an effort to reduce the cost of consumer premise equipment (CPE) used for fixed wireless access applications. No industry standards exist that define the board size and specific mounting hole patterns for radio boards or the antenna size and performance. Constantly changing requirements often necessitate adjusting the mounting hole locations on the radio board, resulting in the need to implement a mounting method that can quickly adapt to such changes without continuously making tool changes to the radio board and antenna enclosure.

The radio board has at least one RF connection between the antenna and the radio board internal to the enclosure system. Each radio board has at least one communication interface connector which carries either RF or digital signals. In prior known enclosures, the communication interface cable extends through a port in a face of the enclosure with a grommet system that seals around the communication interface cable. For efficient enclosure installation in the field, the communication interface connector must be aligned with the port so that the communication interface cable can be directly plugged into the communication interface connector through the grommet system. No industry standards exist that define the location of the connector on the radio board.

### DISCLOSURE OF THE INVENTION

A universal enclosure system for a radio board and an antenna includes an outer housing, a base and a mounting plate. The housing defines a downwardly opening cavity and includes an exterior bracket mount. The bracket mount includes a pair of spaced, downwardly opening bracket bolt plate holders that protrude rearwardly from the back wall of the housing. Each bracket bolt plate holder has a rearwardly opening, elongated, vertical slit. A bracket bolt plate fits into each bracket bolt plate holder, with each bracket bolt plate having two spaced bolts that project rearwardly through the slits. The base fits across the open bottom of the housing, captures the bracket bolt plates in the bracket bolt plate mounts, and closes the cavity defined by the housing. The base includes a downwardly opening access aperture and an access door that covers the access aperture. The access door has a back wall with a plurality of knockouts that can be selectively removed to provide a communications cable port. The base has a plurality of mounting points with the mounting plate attaching to selected mounting points on the base and projecting upwardly. The mounting plate has a plurality of mounting holes at selected locations for mounting different antenna circuits. An antenna circuit is spaced from and attaches to one side of the mounting plate and the mounting plate functions as a ground plane. A radio board mounts on standoffs that are attached to the opposite side of the mounting plate, with the communication interface connector of the radio board facing downwardly. The base includes structure for routing additional cables from the radio board to the exterior of the enclosure.

### BRIEF DESCRIPTION OF THE DRAWINGS

Details of this invention are described in connection with the accompanying drawings that bear similar reference numerals in which:

FIG. 1 is a perspective view of an enclosure system embodying features of the present invention.

FIG. 2 is a rear elevational view of the system of FIG. 1.

FIG. 3 is a bottom plan view of the system of FIG. 1.

FIG. 4 is a bottom plan view of the system of FIG. 1, with the access door removed.

FIG. 5 is an exploded view of the system of FIG. 1.

FIG. 6 is a sectional view of the system of FIG. 1 taken along line 6-6 of FIG. 2.

FIG. 7 is a top plan view of the base of the system of FIG. 1.

FIG. 8 is an exploded view of the base of the system of FIG. 1.

FIG. 9 is a perspective view of the access door for the base for the system of FIG. 1.

FIG. 10 is a perspective view of the base and mounting plate of the system of FIG. 1.

FIG. 11 is a perspective view of the mounting plate of the system of FIG. 1.

### DETAILED DESCRIPTION OF THE INVENTION

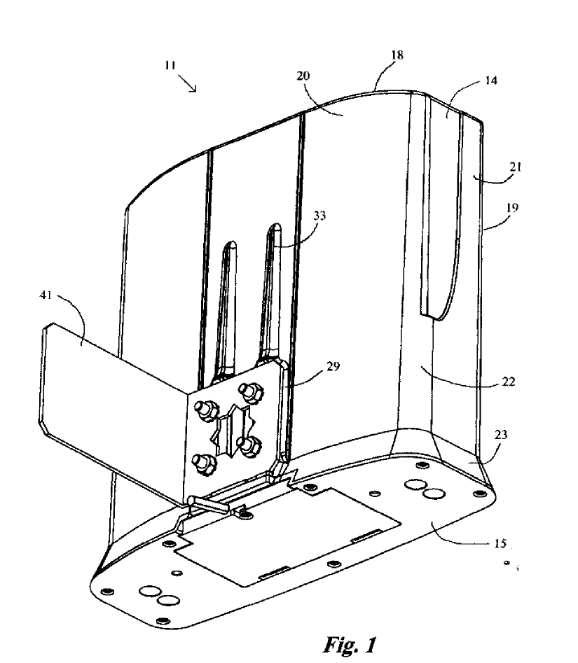

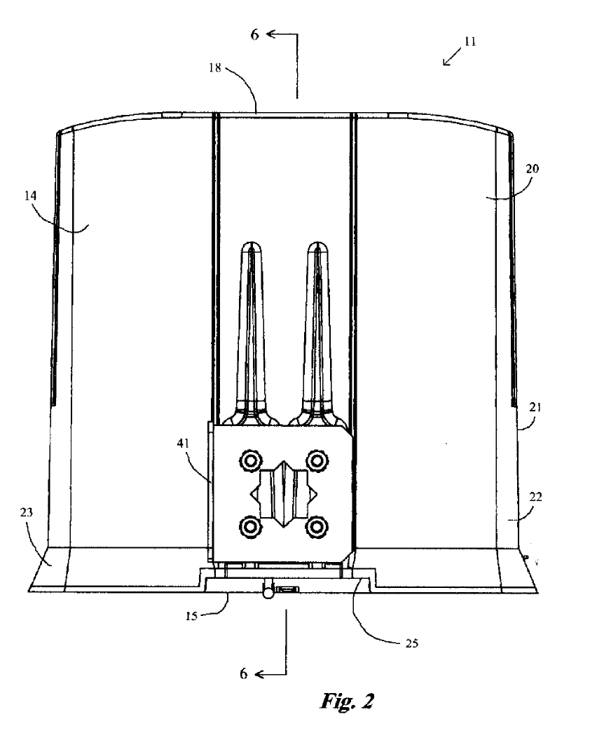

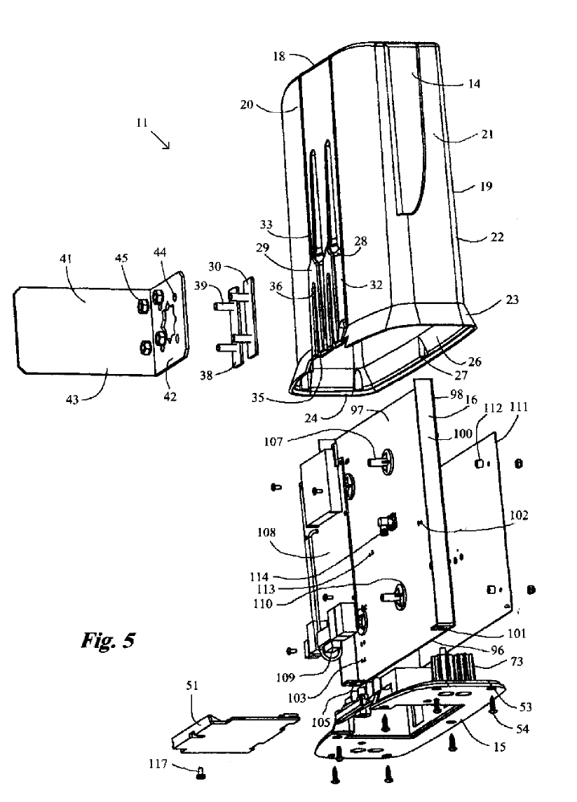

Referring now to FIGS. 1 to 5, a radio board enclosure 11 includes a housing 14, a base 15 and a mounting plate 16. The housing 14 has a generally inverted, oval bucket shape with a top wall 18, a front wall 19, a spaced back wall 20 and spaced, opposed side walls 21. The top wall 18 is slightly convex upwardly and the front, back and side walls 19, 20 and 21 project downwardly from the top wall 18. The front and back walls 19 and 20 are each slightly convex and the side walls 21 are substantially straight. The front and back walls 19 and 20 diverge from each other downwardly, and the side walls 21 diverge from each other downwardly. Rounded corners 22 connect the front and back walls 19 and 20 to the side walls 21.

Describing the specific embodiments herein chosen for illustrating the invention, certain terminology is used which will be recognized as being employed for convenience and having no limiting significance. For example, the terms “top”, “bottom”, “front” and “back” will refer to the illustrated embodiment in its normal position of use. Further, all of the terminology above-defined includes derivatives of the word specifically mentioned and words of similar import.

A bottom portion 23 projects downwardly from the front, back and side walls 19, 20 and 21 and flares outwardly, defining a bottom opening 24 in the housing 14. A horizontally elongated, rectangular portion of the bottom of the bottom portion 23, below the middle of the back wall 20, is cut out to define a cable routing channel 25. The housing 14 defines a downwardly opening housing cavity 26. A plurality of hollow screw protrusions 27 are spaced around the inside periphery of the bottom portion 23.

The housing 14 includes an exterior bracket mount 28 having a pair of spaced, downwardly opening bracket bolt plate holders 29 and a bracket bolt plate 30 for each bracket bolt plate holders 29. The bracket bolt plate holders 29 each have a pair of spaced lateral walls 32 that extend upwardly from the cable routing channel 25 and converge together into an upwardly extending, tapering ridge 33. The lateral walls 32 of each bracket bolt plate holder 29 project rearwardly from the back wall 20 and then inwardly towards each other to define a plate cavity 35. The lateral walls 32 meet along an upper portion of the lateral walls 32 and are separated by a bolt slit 36 that extends upwardly from the bottom of the bracket bolt plate holder 29 along the remainder of the lateral walls 32.

The bracket bolt plates 30 each have a flat, elongated, rectangular plate portion 38 and a pair of spaced, externally threaded studs or bolts 39 that project from the plate portion 38. The bracket bolt plates 30 are sized to fit into the plate cavities 35 of the bracket bolt plate holders 29 with the bolts 39 projecting rearwardly though the bolt slits 36. The mounting bracket 41 shown includes a flat first portion 42 and a flat second portion 43 that extends transversely from the first portion 42. Four bolt apertures 44 extend through the first portion 42. The bolt apertures 44 are sized and positioned to receive the bolts 39, and nuts 45 secure the mounting bracket 41 to the housing 14.

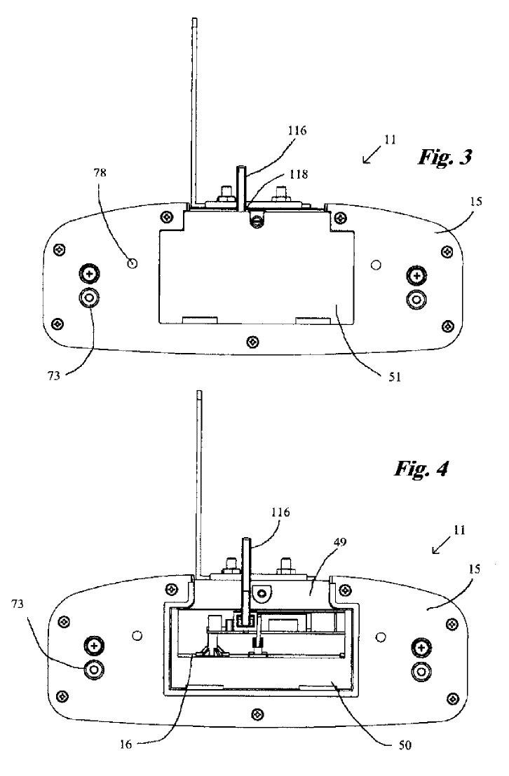

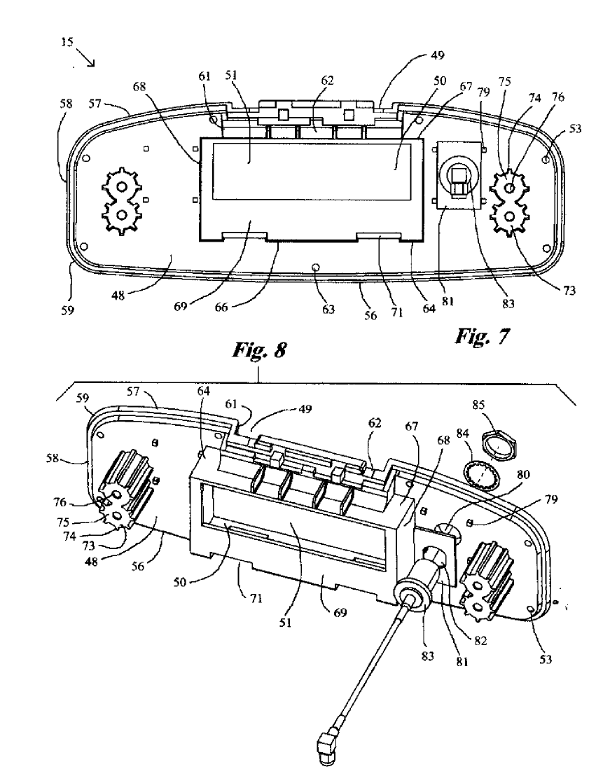

As shown in FIGS. 3, 7 and 8, the base 15 includes a bottom wall 48, a cable routing channel 49, a cable access aperture 50 and a cable access door 51. The bottom wall 48 is substantially flat, and sized and shaped to fit into the bottom portion 23 of the housing 14 and has a plurality of spaced screw apertures 53 that are positioned to align with the screw protrusions 27 in the bottom portion 23 of the housing 14. Housing screws 54 are inserted through the screw apertures 53 and screwed into the screw protrusions 27 to secure the base 15 to the housing 14.

The bottom wall 48 has a slightly convex front edge 56, a spaced, slightly convex back edge 57, a pair of straight, spaced side edges 58, and rounded corner edges 59 connecting the front, back and side edges 56, 57 and 58. The cable routing channel 49 is relieved into the back edge 57 of the bottom wall 48. A pair of spaced lateral walls 61 that project upwardly from the bottom wall 48 and extend inwardly from the back edge 57, and a top wall 62 that extends between the lateral walls 61 define the cable routing channel 49. An access door screw aperture 63 extends through the top wall 62. The lateral and top walls 61 and 62 fit into the cable routing channel 25 in the bottom portion 23 of the housing 14.

The cable access aperture 50 is generally rectangular in shape, extends through the bottom wall 48, and borders the cable routing channel 49. A rectangular peripheral frame 64 surrounds the cable access aperture 50 and has a front wall 66, a spaced back wall 67, and spaced side walls 68. The front wall 66 and side walls 68 project upwardly from the bottom wall 48 of the base 15, and the back wall 67 projects upwardly from the bottom wall 48 of the base 15 and the top wall 62 of the cable routing channel 49. The frame 64 has a top wall 69 that extends between the tops of the side walls 68 from the front wall 66 across a portion of the cable access aperture 50. A pair of spaced, rectangular hook slots 71 extend through the front wall 66 adjacent to the bottom wall 48.

The mounting points 73 are generally hollow cylinders that project upwardly from the bottom wall 48 between the frame 64 and one of the side edges 58. A plurality of spaced ribs 74 project outwardly from each mounting point 73. Each mounting point 73 is open at the bottom and has a closed upper end 75 and a mounting plate screw aperture knockout 76 in the upper end 75. Two mounting points 73 with one of the mounting points 73 being spaced rearwardly of the other are shown on each side of the frame 64. Other structure such as a mounting slot could be provided to increase the number of mounting positions.

The bottom of the bottom wall 48 has a locating dimple 78 on each side between the frame 64 and the mounting points 73. The top of the bottom wall 48 has a rectangular array of locating projections 79 opposite each locating dimple 78. The locating dimple and projections 78 and 79 allow use of alternative cable interconnects. A circular hole 80, centered at the locating dimple 78, is drilled through the bottom wall 48. A rectangular retainer plate 81 with a punched, non-circular connector aperture 82 fits between the locating projections 79. A connector 83, with a non-circular cross-section that matches the connector aperture 82, is inserted through the connector aperture 82 and circular hole 80, and secured by a washer 84 and nut 85. The matching non-circular shapes of the connector 83 and connector aperture 82, combined with the projections 79, prevent rotation of the connector 83 relative to the base 15. The connector 83 shown is a “double D” shape with two parallel flat sections on an otherwise circular cross-section. Another common shape that may be used for the connector 83 is a “D” shape, with a single flat section on an otherwise circular cross-section.

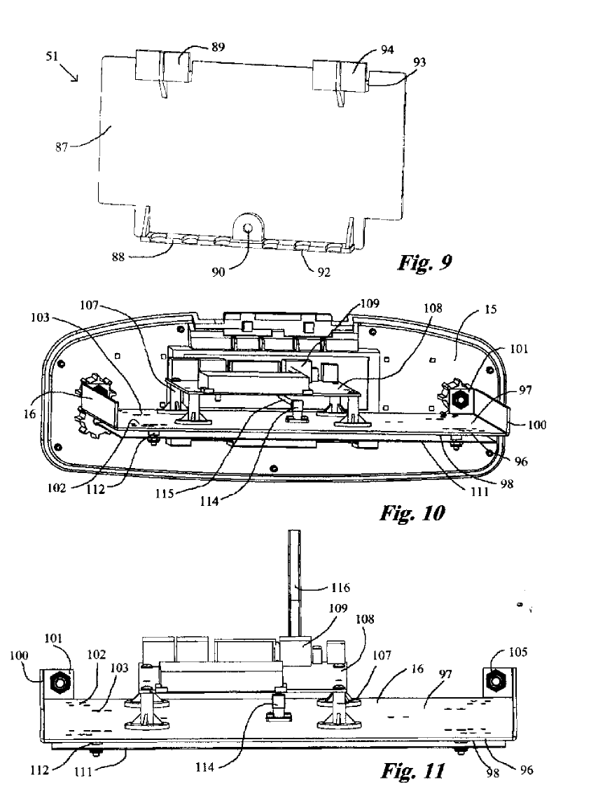

Referring to FIG. 9, the access door 51 is preferably made of a transparent, plastic material and has a door portion 87, a cable access portion 88, a pair of spaced hook portions 89, and an access door screw aperture 90. The door portion 87 is substantially flat, and sized and shaped to fit into and cover the cable access aperture 50. The cable access portion 88 projects upwardly from the back edge of the door portion 87, and is sized and shaped to cover the cable routing channel 49 of the base 15. The cable access portion 88 includes a plurality of spaced, U-shaped knockouts 92, in the form of thin portions of material. The knockouts 92 can be selectively removed for routing a communication interface cable through the cable access portion 88. The hook portions 89 each have an upright section 93 and a horizontal section 94. The upright sections 93 are spaced inwardly from the front edge of the door portion 87, and project upwardly. The horizontal sections 94 extend forwardly from the tops of the upright sections 93 beyond the front edge of the door portion 87. The horizontal sections 94 are sized and positioned to fit into the hook slots 71 in the front wall 66 of the frame 64. The access door screw aperture 90 is positioned to align with the access door screw aperture 63 in the top wall 62 of the cable routing channel 49.

FIGS. 10 and 11 show the mounting plate 16 with a flat, rectangular mounting portion 96 having a first face 97 and a spaced, oppositely facing second face 98, a pair of lateral portions 100 that project transversely from opposite lateral edges of the first face 97, and a pair of spaced mounting tabs 101 that project inwardly from the lower ends of the lateral portions 100. A plurality of arrays 102 of antenna mounting holes 103 extend through the mounting portion 96, providing mounting for various antenna sizes or antennas of different frequencies. Each mounting tab 101 has a mounting screw aperture 105.

A plurality of board standoffs 107 are attached to the first face 97 of the mounting portion 96 and a radio board 108 is mounted on the board standoffs 107, with the communication interface connector 109 of the radio board 108 facing downwards. The board standoffs 107 are selectively positioned for a particular radio board 108. By way of example, and not as a limitation, the board standoffs 107 can be attached to the first face 97 of the mounting portion 96 with adhesive or with screws through the antenna mounting holes 103. The adhesive or screws provide a means for selectively positioning the board standoffs 107. An antenna circuit 111 is mounted on a plurality of antenna standoffs 112 at a selected distance from the second face 98 of the mounting portion 96. Adhesive, or screws through the antenna mounting holes 103, provide a means 113 for selectively positioning the antenna standoffs 107. The mounting plate 16 is preferably made of metal and functions as a groundplane. A transition 114 mounted on the mounting portion 96 and connected to the antenna circuit 111. A coaxial cable 115 connects the transition 114 to the radio board 108.

The mounting tabs 101 of the mounting plate 16 are mounted on selected mounting points 73 on the base 15. The mounting points 73 are selected based on the distance between the antenna circuit 111 and the front wall 19 of the housing 14, and the distance between the antenna circuit 111 and the front wall 19 of the housing 14 is selected based on the RF properties of the antenna circuit 111. If the selected distance between the antenna circuit 111 and the front wall 19 of the housing 14 is smaller, the forward mounting points 73 can be used, and if the selected distance between the antenna circuit 111 and the front wall 19 of the housing 14 is larger, the rearward mounting points 73 are used.

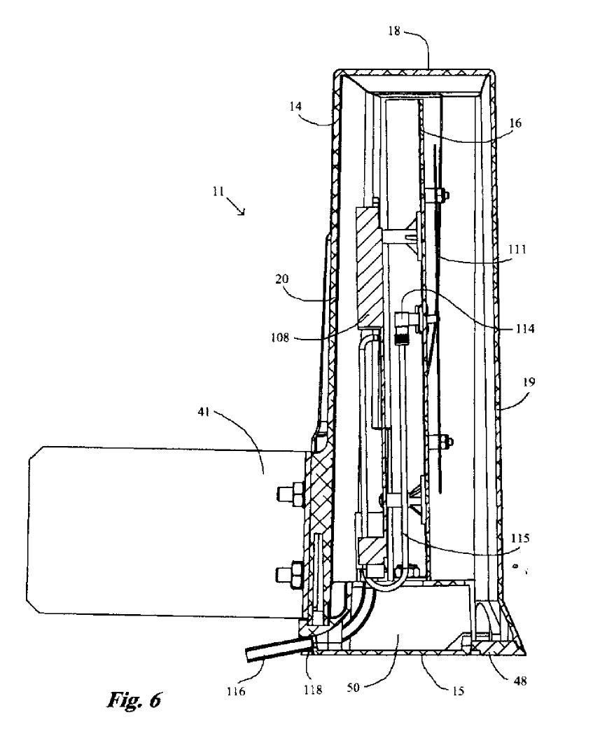

Referring again to FIGS. 3 and 6, the housing 14 is placed over the base 15 and secured to the base 15, with the mounting plate 16 projecting upwardly into the housing cavity 26. If the enclosure 11 is to be mounted outside or in the air, bracket bolt plates 30 are placed in the bracket bolt plate holders 29 prior to assembly of the housing 14 to the base 15. If the enclosure 11 is to be placed on a flat surface, the housing 14 and base 15 can be assembled without the bracket bolt plates 30.

A communication interface cable 116, such as a power over Ethernet (POE) is connected to the communication interface connector 109 on the radio board 108. Based upon the position of the communication interface connector 109 on the lower edge of the radio board 108, a selected knockout 92 on the cable access door 51 is removed to provide a communications cable port 118. The cable access door 51 is assembled to the base 15 with the communication interface cable 116 routed through the communications cable port 118. The cable access door 51 is secured with an access door screw 117 through the access door screw apertures 90 and 63 in cable access door 51 and the top wall 62 of the cable routing channel 49 of the base 15.

The enclosure 11 is substantially weatherproof without the need for gaskets or grommets, and can be used inside or mounted outside. The bracket bolt plates 30 can be removed for inside use. A variety of radio boards 108 and antenna circuits 111 can be used with the enclosure 11. The transparent cable access door 51 allows LEDs on the radio board 108 to be viewed without opening the enclosure 11. The cable routing channel 25 in the bottom portion 23 of the housing and the cable routing channel 49 in the base 15 let the base 15 sit flat on a flat surface.

Although the present invention has been described with a certain degree of particularity, it is understood that the present disclosure has been made by way of example and that changes in details of structure may be made without departing from the spirit thereof.

What is claimed is:

1. A universal enclosure system for a radio board and an antenna comprising:
a housing having a bottom opening and defining an enclosed, downwardly opening housing cavity,
a base sized and shaped to fit into and close said bottom opening, said base being secured in said bottom opening, said base including at least one communications cable port for routing a communications interface cable to said radio board, and
a mounting plate mounted on said base and projecting upwardly into said housing cavity, said mounting plate having a substantially flat mounting portion with a first face, an oppositely facing second face, a plurality of board standoffs selectively positioned on and attached to said first face to space and mount said radio board, and a plurality of antenna standoffs selectively positioned on and attached to said second face to space and mount an antenna circuit for said antenna,
whereby said housing and base are substantially weatherproof without the need for gaskets or grommets.

2. The system as set forth in claim 1 wherein said mounting portion is metal and functions as a groundplane.

3. The system as set forth in claim 2 wherein said mounting portion includes a transition for connecting said radio board to said mounting portion and to said antenna circuit.

4. The system as set forth in claim 1 wherein said mounting plate includes means for selectively positioning said board standoffs.

5. The system as set forth in claim 4 wherein said means for selectively positioning said board standoffs includes adhesive between said mounting portion and said board standoffs.

6. The system as set forth in claim 1 wherein said mounting plate includes means for selectively positioning said antenna standoffs.

7. The system as set forth in claim 6 wherein said means for selectively positioning said antenna standoffs includes a plurality of arrays of antenna mounting holes through said mounting portion.

8. The system as set forth in claim 1 wherein said base has a plurality of mounting points for selectively positioning said mounting plate on said base,
whereby said mounting plate is selectively positioned in said housing cavity.

9. The system as set forth in claim 1 wherein said base has a flat bottom wall,
whereby said base supports said housing in an upright position when said base is placed on a flat surface.

10. The system as set forth in claim 9 wherein said housing has a bottom portion defining said bottom opening, said bottom portion has a cable routing channel, and said base has a cable routing channel coincident with said cable routing channel in said bottom portion,
whereby cables are routed through said cable routing channels in said base and said bottom portion when said base is placed on a flat surface.

11. The system as set forth in claim 10 wherein said bottom wall includes an upwardly opening cable access aperture adjacent to said cable routing channel in said base, and said base includes a removable access door with a door portion that extends across said cable access aperture and a cable access portion, transverse to said door portion, that extends across said cable routing channel in said base, with said communications cable port extending through said cable access portion.

12. The system as set forth in claim 11 wherein said access door is transparent,
whereby LEDs on said radio board can be viewed without removing said base from said housing.

13. The system as set forth in claim 11 wherein said cable access portion includes a plurality of spaced knockouts sized to receive said communications interface cable,
whereby a selected said knockout is removed to selectively position said communications cable port in said cable access portion.

14. The system as set forth in claim 11 wherein said bottom wall has at least one locating dimple spaced from said cable access aperture, said locating dimple being drillable to allow use of alternative cable interconnects.

15. The system as set forth in claim 1 wherein said housing has a back wall that includes an exterior bracket mount having a pair of spaced, downwardly opening bracket bolt plate holders and a removable bracket bolt plate for each said bracket bolt plate holder, each said bracket bolt plate having rearwardly projecting bolts, said base closing said bracket bolt plate holders when said base is assembled to said housing,
whereby said bolts mount said housing to a mounting bracket for outside use without penetrating said housing, and said bracket bolt plates are removed for inside use.

16. The system as set forth in claim 1 wherein said housing has a top wall, a front wall, a back wall spaced from said front wall, and spaced, opposed side walls connecting said front and back walls, said front, back and side walls extending downwardly from said top wall, said top, front, back and side walls defining said enclosed, downwardly opening housing cavity.

17. A universal enclosure system for a radio board and an antenna comprising:
a housing having a top wall, a front wall, a back wall spaced from said front wall, spaced, opposed side walls connecting said front and back walls, and a bottom opening, said front, back and side walls extending downwardly from said top wall to said bottom opening, said top, front, back and side walls defining an enclosed, downwardly opening housing cavity, said back wall having an exterior bracket mount with a pair of spaced, downwardly opening bracket bolt plate holders and a removable bracket bolt plate for each said bracket bolt plate holder, each said bracket bolt plate having rearwardly projecting bolts,
a base sized and shaped to fit into and close said bottom opening, and to close said bracket bolt plate holders, said base being secured in said bottom opening, said base having a removable, transparent access door with a plurality of spaced knockouts, said knockouts being selectively removable to selectively position a communications cable port for routing a communications interface cable to said radio board, said base having a plurality of mounting points, and
a mounting plate projecting upwardly into said housing cavity, and mounting on selected said mounting points on said base to selectively position said mounting plate in said housing cavity, said mounting plate having a substantially flat, metal mounting portion with a first face, an oppositely facing second face, a plurality of board standoffs selectively positioned on and attached to said first face to space and mount said radio board, and a plurality of antenna standoffs selectively positioned on and attached to said second face to space and mount an antenna circuit for said antenna, said mounting portion including a transition for connecting said radio board to said mounting portion and to said antenna circuit,
whereby said housing and base are substantially weatherproof without the need for gaskets or grommets, and a variety of different radio boards and antenna circuits can be mounted on said mounting plate and enclosed in said housing.
